(19) United States
(12) Patent Application Publication
(10) Pub. No.: US 2004/0088893 A1
(43) Pub. Date: May 13, 2004

(54) Greeting card with aligned characters and windows

(76) Inventor: Greg Vincent Mahoney, Phoenix, AZ (US)

Correspondence Address: GREG V. MAHONEY, 19442 N. 23rd WAY, PHOENIX, AZ, 85024, US

(21) Appl. No.: 10/293,758

(22) Filed: Nov. 13, 2002

(51) Int. Cl. G09F 1/00

(52) U.S. Cl. 40/124.11

(57) ABSTRACT

A greeting card including a front panel having a visible first greeting and an inside panel having a visible second greeting that is aligned with said first greeting in such a way as to allow selected identical characters of said second greeting to be viewed through multiple cutout windows in said front panel and complete said first greeting.

### BACKGROUND OF THE INVENTION

The present invention relates to greeting cards and more particularly to a new multiple window greeting card with a printed greeting on both the front panel and inside panel incorporating aligned identical characters on said inside panel that when viewed through the multiple cutout windows in said front panel complete said first greeting.

The use of greeting cards is known in the prior art and has many variations on the themes of word phrases, puzzles and pictures that are typically viewed through a single cutout window, or various translucent materials to amuse the card recipient.

Known prior art greeting cards include U.S. Pat. No. 2,547,359; U.S. Pat. No. 3,061,971; U.S. Pat. No. 3,484,971; U.S. Pat. No. 3,822,901; U.S. Pat. No. 4,070,778; U.S. Pat. No. 4,512,581; U.S. Pat. No. 4,586,714; U.S. Pat. No. 4,826,211; U.S. Pat. No. 5,117,569; U.S. Pat. No. 5,149,097; U.S. Pat. No. 5,261,703; U.S. Pat. No. 5,551,730; U.S. Pat. No. 5,890,744; U.S. Pat. No. 5,906,063; U.S. Pat. No. 5,941,573; and U.S. Pat. No. 6,199,912.

The present invention recognizing the desirability of providing a greeting card not requiring any assembly or manipulation, but providing an amusing and unexpected realization of the interrelation of the different greetings on the front and inside panel through a unique alignment of selected identical characters as highlighted by multiple cutout windows. Other types of greeting cards exist using a single window as a frame for an entire word phrase or picture, but none use multiple windows to expose identical characters of uniquely aligned greetings on the two or more panels of the card.

Other and further features of the invention will be evident to one skilled in the greeting card art upon reading the disclosure set forth herein.

### BRIEF SUMMARY OF THE INVENTION

The present invention relates to a novel new greeting card with printed greetings on both the front panel and inside panel that incorporate aligned identical characters on said panels with said aligned identical characters on said inside panel completing said front panel greeting when viewed through the multiple cutout windows in said front panel.

The objective of the present invention, which will be described subsequently in greater detail, is to provide a new aligned character and window greeting card which is not anticipated, rendered obvious, suggested or even implied by any of the prior art greeting cards, either alone or in any combination thereof. To attain this, the present invention comprises:

### BRIEF DESCRIPTION OF THE SEVERAL VIEWS OF THE DRAWING

FIG. 1 is an isometric view of a partially opened greeting card in the form of a single horizontally folded sheet incorporating the features of the invention, disclosing the front face of the front plate and a portion of the inside face of the back plate of said greeting card;

FIG. 2 is a plan view of said greeting card of FIG. 1. in open form disclosing the front face of the front plate thereof, and disclosing a visible first greeting printed thereon, and disclosing multiple cutout windows allowing aligned identical characters from a second greeting printed on said inside face of said back plate to show through;

FIG. 3 is a plan view of said greeting card of FIG. 1 in open form, disclosing said inside face of said back plate thereof, and disclosing said second greeting, and disclosing the aligned identical characters shared with said first greeting as illustrated in bold letters on said FIG. 3, visible through said cutout windows in said front plate.

FIG. 4 is a plan view of said front face of said front plate of said greeting card of FIG. 1 in closed form, disclosing the alignment of said identical characters of said first and second greetings, and disclosing one of the purposes of said cutout windows.

The above description and examples should not be construed as limitations on the scope of the invention, many other variations are possible. Accordingly, the scope of the invention is determined by the claims and their legal equivalents.

### DETAILED DESCRIPTION OF THE INVENTION

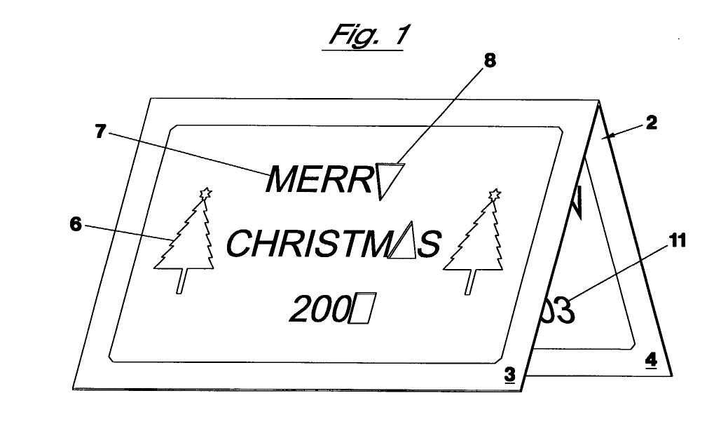

Referring to FIG. 1 of the drawings, a rectangular shaped single horizontally folded sheet greeting card 2 incorporating the unique features of the present invention is disclosed in the form of said greeting card 2 having a front plate 3 and a back plate 4 so as to include front and back faces to provide appropriately selected areas to accommodate the several features of the invention. It is to be understood that the present invention is not limited to the rectangular shaped single horizontally folded sheet shown on the drawings but that other geometrically shaped greeting cards can be utilized or multiple sheets and other folding patterns incorporated to provide appropriate areas for the invention.

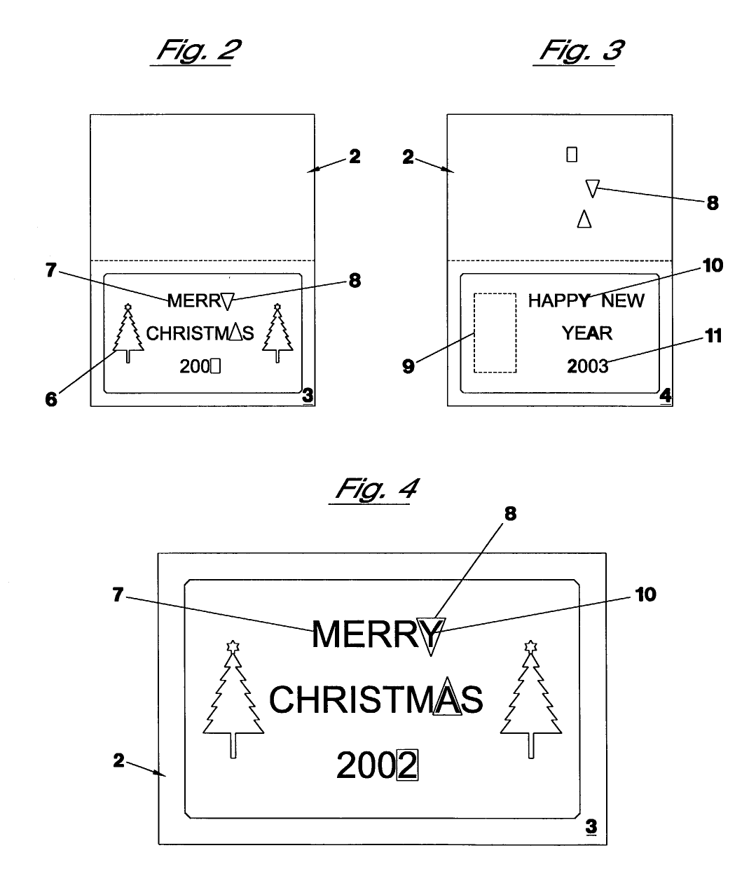

As can be seen in FIG. 2 said front face of front plate 3 of said greeting card 2 is provided with a first area including a visible first greeting to a card recipient printed thereon. Here it is shown as a drawing 6 and an accompanying greeting 7, said drawing being in the form of two Christmas trees with said accompanying greeting . . . “Merry Christmas 2002” . . . having selected characters of said first greeting completely cut out in various geometric shapes to form windows.

As can be seen in FIG. 3 said cutout windows 8 allow viewing of selected aligned identical characters 10 of said first and second greetings, allowing only said identical characters of said second greeting to be visible to complete said first greeting, with said second greeting 11 . . . “Happy New Year 2003” . . . incorporating an adjacent blank area 9 for writing personal salutations specifically for each card recipient.

Thus in accordance with the present invention, a novel greeting card with aligned characters and windows is provided which can be readily and economically manufactured to incorporate a variety of greeting themes affording to the card recipient both the pleasure of two or more memorable greetings and the added entertainment, afforded by the cutout windows, of the unique alignment and interrelation of said greetings.

The invention claimed is:

1. A greeting card including a first area having a visible first greeting; a second area having a visible second greeting that is aligned with said first greeting in such a way as to allow selected aligned identical characters of said second greeting to be viewed through multiple cutout windows in said first area and complete said first greeting.

2. The greeting card of claim 1, said greeting card being in the form of a rectangular single horizontally folded sheet to include a front plate and back plate with two inside faces with said first area having a visible first greeting printed on said front face of said front plate.

3. The greeting card of claim 2, said back plate having said second area with a visible second greeting printed on said inside face and aligned in such a way with said first greeting to allow the sharing of said selected aligned identical characters common to said first and second greetings.

4. The greeting card of claim 2, said front plate having said selected aligned identical characters of said first greeting completely cut out to form multiple geometrically shaped windows allowing the viewing of only said selected aligned identical characters of said second greeting to complete said first greeting.

5. A greeting card consisting essentially of: A rectangular single horizontally folded sheet having front and back plates to include front and back faces and two inside faces to provide at least four plate areas including a first area on said front face of said front plate having a visible first greeting printed thereon; a second area on said inside face of said back plate having a visible second greeting printed thereon and aligned with said first greeting within a distance to accommodate for manufacturing tolerances to allow sharing of selected identical characters of said first and second greetings and to allow only said aligned identical characters of said second greeting to be viewed through said multiple geometrically shaped cutout windows in said front plate.
